(19) United States
(12) Patent Application Publication
(10) Pub. No.: US 2001/0040161 A1
(43) Pub. Date: Nov. 15, 2001

(54) Container and latch wipe therefor

(75) Inventor: Dennis M. Peters, Mason, MI (US)

Correspondence Address: MCGARRY BAIR LLP, 171 MONROE AVENUE, SUITE 600, GRAND RAPIDS, MI, 49503, US

(73) Assignee: Dart Container Corporation, Mason, MI (US)

(21) Appl. No.: 09/909,011

(22) Filed: Jul. 19, 2001

Related U.S. Application Data
(62) Division of application No. 09/429,206, filed on Oct. 28, 1999.

(51) Int. Cl. B65D 43/16; B29C 51/32; B29C 51/42

(52) U.S. Cl. 220/4.23; 220/835; 220/839; 264/154; 264/327; 425/290; 425/399

(57) ABSTRACT

A container for holding food items and the like. The container comprises a base for holding the food item and a cover hingedly mounted to the base and movable between an open and closed position. The cover has a latch wipe opening that is sized to receive a tab extending from the base. The latch wipe opening has a generally rectangular shape. During the manufacturing process, the material in which the latch wipe opening is formed is pre-cooled to reduce the tendency of the latch wipe opening to deform. Further, the form against which the latch wipe opening is formed has a knurled portion that engages the container material above the latch wipe opening to further prevent the deforming of the latch wipe opening during manufacturing.

### CROSS-REFERENCE TO RELATED APPLICATIONS

This application claims the benefit of U.S. Provisional Application Serial No. 60/117,377, Jan. 27, 1999.

### BACKGROUND OF THE INVENTION

1. Field of the Invention

The invention generally relates to a container, and more specifically, a molded foam container having a cover hingedly mounted to a base and having a tab received within a latch wipe opening on the cover to lock the cover in the closed position relative to the base.

2. Related Art

Foam containers are commonly used for takeout food. A typical foam container comprises an open-top base sized to receive food items, in combination with a cover that closes the open top of the base. The cover is usually hingedly connected to one side of the base and has a latch wipe opening sized to receive a tab on the base to hold the cover in the closed position.

The base and cover are generally molded as a single piece and can be made from any suitable material. In applications where hot food is to be placed within the base, it is preferred that the container be molded from a material having insulating characteristics such as foamed polystyrene. One problem encountered by current foam containers and their manufacturing processes is that the latch wipe opening is often deformed during manufacturing into a shape in which it no longer easily retains the cover tab, resulting in wasted product or a poor-performing product.

An example of a common deformity is that associated with a rectangular latch wipe opening, disclosed in FIG. 1. The outer end of the rectangular latch wipe opening and both edges can change shape during manufacturing from the preferred and initial rectangular shape to a more ovate shape, which is referred to as “smiling.” If the degree of smiling is great enough, the locking tab cannot be retained within the latch wipe opening.

### SUMMARY OF THE INVENTION

The invention addresses the problem of the prior art latch wipe opening smiling effect by pre-cooling a portion of the foam sheet which will become the bottom edge of the latch wipe opening. The pre-cooling stabilizes the area and reduces the contraction of the foam as it cools so a rectangular wipe can be maintained. Smiling reduction is further accomplished by holding a portion of the material surrounding the latch wipe opening to prevent its movement during thermoforming by using a textured protruding plate to cool, grip and hold the inner portion of the latch wipe during the wiping process.

In one embodiment, the invention relates to a method for thermoforming a container from a heated foam sheet in a mold comprising upper and lower mold halves that are capable of relative movement between an open position and a closed position. An interior form is provided on one of the mold halves for shaping the interior of the container and an exterior form is provided on the other mold half for shaping the exterior of the container. The container comprises a base having a bottom wall from which extends an upstanding peripheral wall. The container further comprises a cover, which is hingedly mounted to the base, with a top wall and a peripheral wall depending therefrom. One of the peripheral walls has a latch wipe opening and the other of the peripheral walls has a locking tab that is sized to be received within the latch wipe opening to lock the cover in a closed position relative to the base. The method comprises the steps of positioning the heated foam sheet between the open mold halves, moving the mold half toward the closed position, and pre-cooling a first portion of the foam sheet adjacent to the location where the latch wipe opening will be formed.

The method can also include the holding of a second portion of the foam sheet adjacent to the location where the latch wipe opening will be formed. The holding of the second portion can include pressing the second portion of the foam sheet against a textured surface on the interior form.

The pre-cooling step can include contacting the first portion of the foam sheet with a portion of one of the mold halves, preferably a flange extending upwardly from one of the mold halves. The pre-cooling step can further include the pre-cooling of the foam sheet second portion in addition to the pre-cooling of the foam sheet first portion.

In another embodiment, the invention relates to an apparatus for thermoforming a container from a heated foam sheet. The container comprises a base having a bottom wall and an upstanding peripheral wall along with a cover, which is hingedly mounted to the base, with a top wall and a depending peripheral wall. One of the peripheral walls has a latch wipe opening and the other of the peripheral walls has a locking tab that is sized to be received within the latch wipe opening to lock the cover in a closed position relative to the base. The apparatus comprises upper and lower mold halves, each of which includes an inner surface, which are in opposing relationship. One of the inner surfaces has a container-forming portion that defines the interior of a container and the other of the upper surfaces has a container-forming portion that defines the exterior of a container. The mold halves are movable between an open position permitting the insertion of a foam sheet and a closed position where a foam sheet positioned between the mold halves conforms to the container-forming portions to form a container. A flange with a cooling surface extends from one of the inner surfaces a sufficient distance so that a first portion of a heated sheet adjacent to the location where the latch wipe opening will be formed contacts the cooling surface prior to contacting the container-forming portion of the one of the inner surfaces as the mold halves are moved to the closed position to thereby pre-cool a portion of the heated sheet.

Preferably, the apparatus further comprises one or more pairs of inner and outer forms, which together form the interior and exterior surfaces of the container. A textured surface can be provided on the container-forming portion of the one of the inner surfaces at a position where a second portion of a foam sheet adjacent to the location where a latch wipe opening will be formed. The textured surface is preferably a knurled portion on the upper surface container-forming portion defining a container interior.

A shear key can also be provided on the upper surface container-forming portion defining a container interior and positioned below the knurled portion whereby upon the closure of the mold halves, the shear key forms a slit in the foam sheet to create the latch wipe opening in the knurled portion grips a portion of a foam sheet above the slit to control the shape of the latch wipe opening.

Preferably, the height and position of the flange are selected such that a portion of a foam sheet contacting the flange will lie below the shear key upon complete closure of the mold halves. The flange is movably mounted to the mold half having said one inner surface and is movable between an extended position where the cooling surface is positioned above said one inner surface when the mold halves are open and a retracted position where the cooling surface is substantially coplanar with said one inner surface when the mold halves are closed.

The mold halves can have an internal fluid conduit through which a coolant is passed to maintain the flange cooling surface in a temperature less than the temperature of a foam sheet for forming the container.

In a third embodiment, the invention relates to a foam container comprising a base having a bottom wall and a peripheral wall extending from the bottom wall, with a latch wipe opening formed in the peripheral wall. The container further includes a cover having a top wall and a peripheral wall extending from the top wall, with a locking tab extending from the cover peripheral wall. The cover peripheral wall is hingedly mounted to the base peripheral wall for movement between a closed position where the cover overlies the base and an open position where the cover is retracted from the base. The locking tab is sized to be received within the latch wipe opening to lock the cover in the closed position. The latch wipe opening is formed by pre-cooling a portion of the foam sheet forming the container at a location adjacent to the latch wipe opening.

### BRIEF DESCRIPTION OF THE DRAWINGS

In the drawings:

FIG. 1 illustrates a prior art latch wipe opening having the smiling characteristic;

FIG. 2 is a perspective view of a container made according to the invention;

FIG. 3 is a sectional view taken along line 3-3 of FIG. 2;

FIG. 4 illustrates a forming station having upper and lower mold halves that in combination with a sheet of foam material are used to manufacture the container according to the invention;

FIG. 5 is a perspective view of a portion of the lower mold half illustrating an inner form and a flange clamp in the raised position for reducing the smiling effect on the latch wipe;

FIG. 6 is similar to FIG. 5 but shows the flange clamp in the lowered position;

FIG. 7 is a side-sectional view of the sheet material and its relationship to the upper and lower mold halves as they begin to contact the sheet during the molding process;

FIG. 8 is a side-sectional view similar to FIG. 7 and illustrating the relative positions of the sheet material, upper and lower mold halves, and the flange clamp just as the sheet material makes contact with the flange clamp during closure of the mold;

FIG. 9 is a side-sectional view similar to FIG. 8 and illustrating the relative positions of the sheet material, the upper and lower mold halves, and the flange clamp, when shear keys on the upper and lower mold halves engage the sheet material to form the latch wipe opening; and

FIG. 10 is a side-sectional view similar to FIG. 7 and illustrating the relationship between the sheet material, the upper and lower mold halves, and the flange clamp when the mold halves are in the closed position.

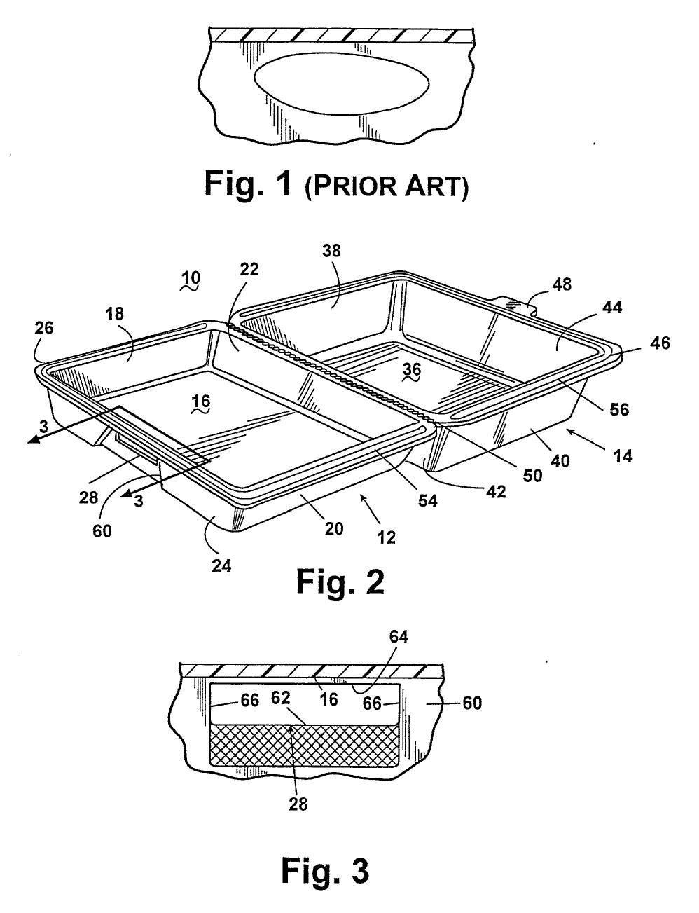

### DETAILED DESCRIPTION

FIG. 2 illustrates a container 10 according to the invention, and comprising a cover 12 and a base 14. The cover 12 has a top wall 16 from which extend a pair of side walls 18, 20, a back wall 22, and a front wall 24. The side walls 18, 20, back wall 22, and front wall 24 all terminate at a peripheral lip 26. A latch wipe opening 28 is provided in the front wall 24 adjacent to the peripheral lip 26.

The base 14 has a structure similar to the cover 12 and comprises a bottom wall 36 from which extend a pair of side walls 38, 40, a back wall 42, and a front wall 44, all of which terminate in a peripheral lip 46. A locking tab 38 extends from the base front wall 44 near the peripheral lip 46. The locking tab 48 can be formed as a portion or part of the peripheral lip 46 or can be completely independent of the peripheral lip 46.

Preferably, the cover 12 and base 14 are hingedly connected by joining the peripheral lips 26 and 46 along the back walls 22, 42 to form a hinge 50. By hingedly joining the cover 12 and base 14 in this manner, the cover 12 can rotate about the hinge 50 into a position where it overlies the base 14 and the locking tab 48 is received within the latch wipe opening 28 to lock the cover with respect to the base.

Looking at the cover 12 and base 14 in greater detail, the cover peripheral lip 26 is formed with a rib 54 sized to be received within a channel 56 in the base peripheral lip 46. The rib 54 and channel 56 are generally U-shaped and extend along their respective front walls and side walls. The rib 54 and channel 56 form a seal to help retain heat and fluid within the container when closed.

The latch wipe opening 28 will now be described in greater detail with general references to FIG. 2 and with specific reference to FIG. 3, which illustrates the latch wipe opening 28 from inside the cover 12. The latch wipe opening 28 is formed in an inset portion 60 of the cover front wall 24 and has a rectangular shape defined by an upper edge 62, lower edge 64, and side edges 66. The lower edge 64 is generally adjacent to the peripheral lip 26. The front wall is formed with a textured or knurled portion 68 provided above the upper edge 62 of the latch wipe opening 28.

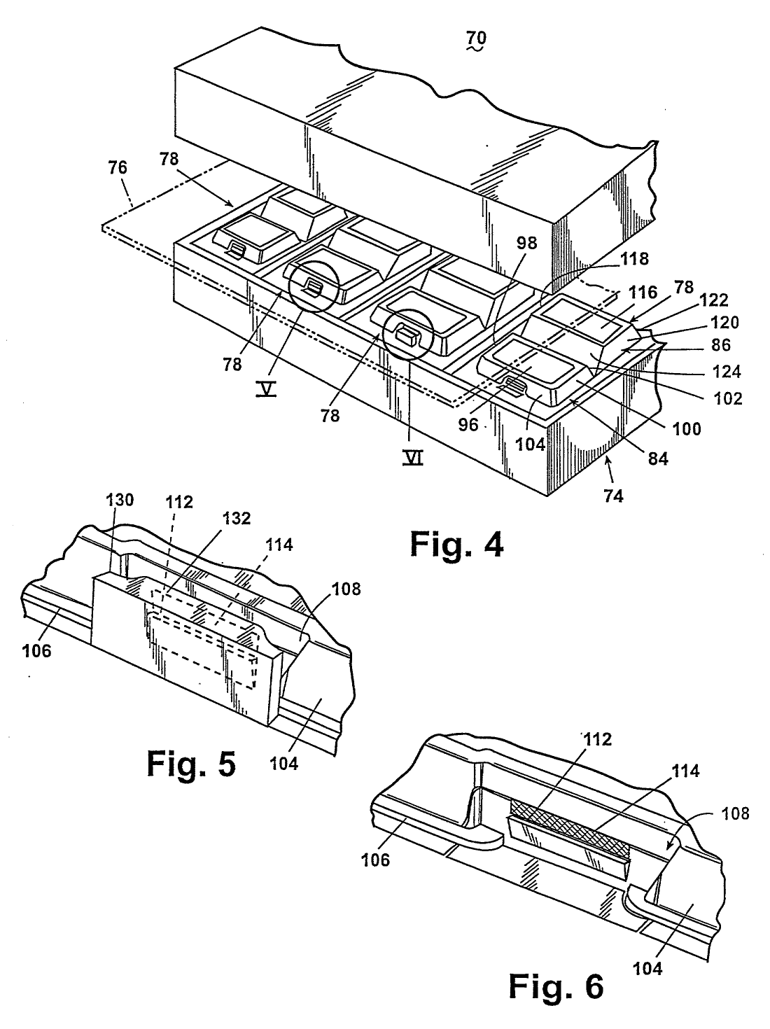

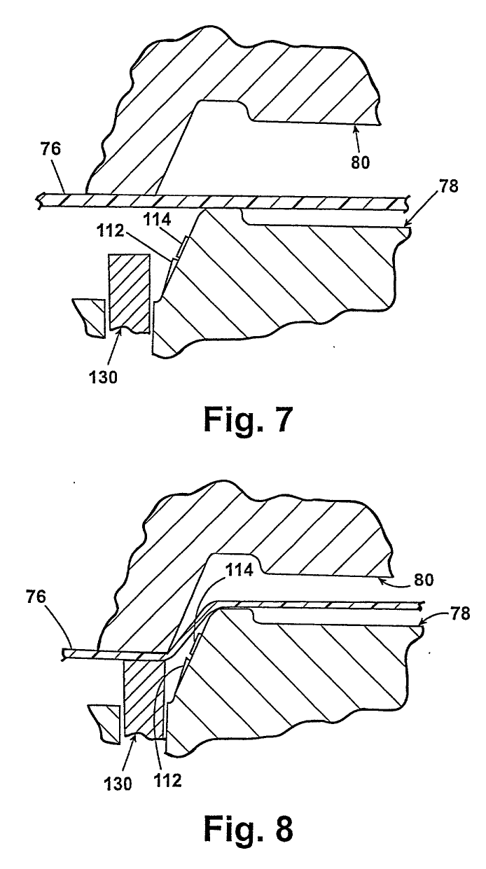

The manufacturing process of the container 10 is illustrated in FIGS. 4-10. FIG. 4 illustrates a typical forming station 70 at which multiple containers 10 are formed. The forming station 70 comprises an upper mold half 72 and a lower mold half 74 between which is fed a sheet 76 (shown in phantom) of material from which the containers 10 are made. The sheet material 76 is preferably foamed polystyrene and is a continuous, indexed sheet. The upper and lower mold halves 72, 74 both have multiple complementary interior form 78 and exterior form 80 (FIGS. 7-10) mold forms that in combination form the individual containers 10.

Referring to FIGS. 4-6, the interior form 78 comprises a cover portion 84 and a base portion 86, which are complementary in shape to the interior of the finished cover 12 and base 14 of the container 10. The cover portion 84 includes top wall 96, side walls 98, 100, back wall 102, and front wall 104, all of which correspond to the similar walls on the finished container 10. The cover portion 84 further includes a channel 106 that forms the rib 54 on the finished container 10. An inset portion 108 is formed in the front wall 104 of the interior form 78 to form the inset portion 60 on the finished container 10.

The inset portion 108 of the interior form 78 includes a shear key 112 and a knurled portion 114. The knurled portion 114 is positioned above the shear key 112. The knurled portion 114 extends beyond the surface of the inset portion 108, preferably by approximately half the container wall thickness.

The base portion 86 includes a bottom wall 116, side walls 118, 120, back wall 122, and front wall 124, all of which respectively form the corresponding parts of the base 14 of the finished container 10. A rib extends from the base portion 86 of the interior form 78 and forms the channel 56 on the container 10.

The exterior form 80 generally conforms to the shape of the interior form 78. Therefore, wherever the interior form 78 has a projection or recess, the lower form will have a complementary recess or projection. Therefore, the upper form will not be described in detail.

The interior form 78 further includes a flange clamp 130 that is movable between a raised position (FIG. 5, 7) and a lowered position (FIG. 6, 10), flush with the upper surface of the interior form 78. The flange clamp 130 has an upper surface 132, which generally conforms to the upper surface of the interior form 78. The flange clamp 130 is positioned in front of the inset portion 108 of the interior form 78 and cools the portion of the sheet material immediately below the latch wipe opening 28 prior to that portion of the sheet material being formed against the front wall 104 of the cover portion 84.

The thermoforming process of the container 10 according to the invention will now be described with respect to FIGS. 4-10. During the thermoforming process, the upper and lower mold halves 72, 74 are separated and the sheet material 76 is moved between the open mold halves 72, 74. The sheet material is initially preheated to a temperature of approximately 260° F. to 300° F. The preheating of the sheet material aids in its subsequent forming by permitting the material to stretch or flow without tearing.

Referring to FIG. 7, the mold halves 72, 74 are then simultaneously moved toward each other. As the mold halves are closed, they make contact with the sheet material 76. At the point where the mold halves 72, 74 initially make contact with the sheet material, the upper surface 132 of the flange clamp 130 is still slightly disposed below and not contacting the sheet material 76.

Referring to FIG. 8, upon the continued closure of the mold halves 72, 74, the sheet material begins to follow the contour of the upper and lower mold halves and the upper surface 132 of the flange clamp 130 makes contact with the lower surface of the sheet material 76. The contact between the sheet material and the flange clamp upper surface occurs approximately ½ inch from complete mold closure for the particular container shown in the drawings. Since the mold halves 72, 74 are generally kept at a temperature lower than the sheet material 76, the contacting of the sheet material with the upper surface 132 of the flange clamp 132 cools that portion of the sheet material faster than the portions of the sheet material that are not in contact with the mold halves 72, 74. The upper surface 132 of the flange clamp 130 is strategically located to contact and cool the sheet immediately below the portion of the sheet material in which the latch wipe opening 28 is ultimately formed. The time that the sheet material remains in contact with the flange clamp prior to formation of the latch wipe controls the pre-cooling effect that the flange clamp has on the sheet material for a given flange clamp temperature. The contact time is generally a function of the machine variables including the speed at which the mold halves close and the time they remain closed.

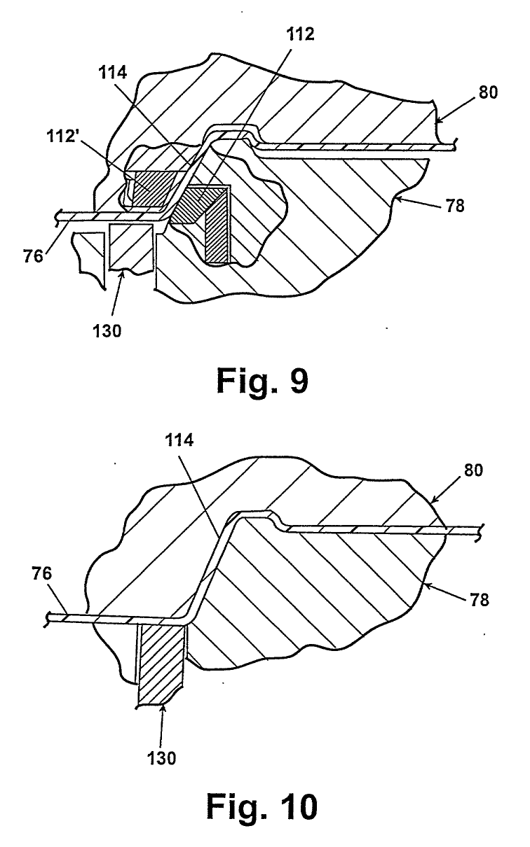

Referring to FIG. 9, as the mold halves 72, 74 continue closing, the flange clamp 130 is urged downwardly. The mold halves 72, 74 ultimately close a sufficient distance, approximately ¼ inch, where the shear key 112 and a corresponding shear key 112′ on the exterior form begin contacting opposite sides of the sheet material 76 at the point where the latch wipe opening 28 is to be formed. The shear keys 112, 112′ displace the sheet material 76, which is still warm enough to move, to form the latch wipe opening 28.

Prior to the shear keys 112, 112′ forming the latch wipe opening 28, the sheet material 76 makes contact with the knurled portion 114. The knurled portion 114, like the rest of the form, is kept at a lower temperature than the sheet material. Thus, as the sheet material makes contact with the knurled portion, this portion of the sheet material is cooled. While this portion of the sheet material is pre-cooling because of its contact with the knurled portion of the form, the material is still warm enough to easily stretch or flow about the ridges and valleys in the knurled portion, which effectively grip the sheet material. Since the knurled portion extends out from the surface of the interior form 78, the portion of the sheet material contacting the knurled portion 114 is slightly compressed as the mold halves 72, 74 close to thereby hold the sheet material in the gripped position. The portion of the sheet material above the latch wipe opening 28 is thus pre-cooled, gripped, and held during the thermoforming process to retard the tendency of the sheet material to smile during the thermoforming process.

Referring to FIG. 10, the mold halves 72, 74 are completely closed and the flange clamp 130 is flush with the upper surface of the interior form 78. In this position, the portion of the sheet material that was in contact with the flange clamp is slightly compressed between the mold forms. A vacuum is now applied to increase the surface contact between the sheet material and the lower mold half 74. Liquid coolant circulating through the mold halves then results in cooling of the sheet material.

To complete the thermal molding process, the mold halves 72, 74 are opened and the formed sheet is removed and cut into individual containers 10.

The container made according to the invention is superior relative to the prior art because the latch wipe opening is kept rectangular, permitting the proper functioning of the locking tab. The rectangular latch wipe opening is obtained by pre-cooling the portions of the sheet material above and below the area where the latch wipe opening is to be formed. Specifically, the sheet material above the latch wipe opening, in other words, opposite the mold closure direction, is cooled, gripped and held in place during the forming of the latch wipe opening, by the protruding knurled plate which tends to keep the sheet material above the opening from deforming once the sheet material is slit to form the latch wipe opening.

Although the invention is described with the portion of the sheet material below the latch wipe opening being pre-cooled by contact with the flange clamp and a portion of the sheet material above the latch wipe opening is pre-cooled by contacting the form, gripped by the knurled portion of the form, and held by compression between the upper form and the knurled portion, it is within the scope of the invention for any of these methods to be used alone or in combination to limit the smiling effect associated with the creation of the latch wipe opening. The particular combination of pre-cooling, gripping, and holding will be selected depending on the type of container being molded and the location of the latch wipe opening.

For example, in the preferred embodiment described above, the amount of pre-cooling is different for the material above and below the latch wipe opening because the material above the latch wipe opening has a shorter contact time with the knurled portion than the contact time between the lower portion of the material and the flange clamp. The knurled portion is added to provide a mechanical holding to the latch wipe upper edge in addition to the material property effect obtain by pre-cooling. Depending on the location of the latch wipe opening and the shape of the container, it may be desirable to have a knurled portion both above and below the latch wipe opening, which can optionally include a flange clamp for pre-cooling the portion of the sheet material below the latch wipe opening. Alternatively, it is within the scope of the invention to exclude the use of the knurled portion above the latch wipe opening. In almost all configurations, there will inherently be some degree of pre-cooling and compressive holding because the forms are maintained at a temperature below that of the sheet material and the sheet material is compressed between the forms as they close.

Although the pre-cooling is illustrated as being accomplished by the use of a moveable flange clamp, it is within the scope of the invention for other suitable mechanisms and devices to achieve the pre-cooling. For example, additional pre-cooling can be created by cooling a portion of the form above and below the latch wipe opening to a cooler temperature than the rest of the form. However, a discrete cooling solution is substantially more expensive than the preferred embodiment. Also, the gripping function can be accomplished by mechanical devices other than forming a knurled portion in the form.

While the invention has been specifically described in connection with certain specific embodiments thereof, it is to be understood that this is by way of illustration and not of limitation, and the scope of the appended claims should be construed as broadly as the prior art will permit.

1. A method of thermoforming a container from a heated foam sheet in a mold comprising upper and lower mold halves capable of relative movement between open and closed positions, an interior form on one of the mold halves for shaping the interior of the container, and an exterior form on the other mold half for shaping the exterior of the container, the container comprising a base having a bottom wall and a peripheral wall upstanding from the bottom wall, and a cover hingedly mounted on the base and having a top wall and a peripheral wall depending from the top wall, one of the peripheral walls having a latch wipe opening therein, and the other of the peripheral walls having a locking tab sized to be received within the latch wipe opening to lock the cover in a closed position relative to the base, the method comprising the steps of:
positioning the heated foam sheet between the mold halves in the open position thereof;
moving the mold halves toward the closed position thereof;
pre-cooling a first portion of the foam sheet adjacent to the location where the latch wipe opening is to be formed; and
forming the latch wipe opening in the foam sheet.

2. The method according to claim 1, further comprising the step of holding a second portion of the foam sheet adjacent to the location where the latch wipe opening is to be formed.

3. The method according to claim 2, wherein the holding step comprises pressing the second portion of the foam sheet against a textured surface on the interior form.

4. The method according to claim 3, wherein the pre-cooling step comprises contacting the first portion of the foam sheet with a portion of one of the mold halves.

5. The method according to, claim 3, wherein the pre-cooling step comprises contacting the first portion of the foam sheet with a flange extending outwardly from one of the mold halves.

6. The method according to claim 4, wherein the contacting step is carried out prior to the movement of the mold halves to the closed position.

7. The method according to claim 2, wherein the first and second portions of the foam sheet are free from overlapping with each other.

8. The method according to claim 7, wherein the first portion of the foam sheet is disposed closer to the mold half having the interior form than is the location where the latch wipe opening is to be formed.

9. The method according to claim 8, wherein the second portion of the foam sheet is disposed farther from the mold half having the interior form than is the location where the latch wipe opening is to be formed.

10. The method according to claim 2, wherein the pre-cooling step further comprises pre-cooling the second portion of the foam sheet.

11. The method according to claim 10, wherein the pre-cooling of the second portion of the foam sheet comprises moving the second portion into contact with a portion of the interior form.

12. The method according to claim 11, wherein the holding and pre-cooling of the second portion of the foam sheet second portion comprises moving the second portion into contact with a textured portion of the interior form.

13. The method according to claim 1, wherein the pre-cooling step comprises contacting the first portion of the foam sheet with a portion of one of the mold halves.

14. The method according to, claim 1, wherein the pre-cooling step comprises contacting the first portion of the foam sheet with a flange extending outwardly from one of the mold halves.

15. The method according to claim 14, wherein the contacting step is carried out prior to the movement of the mold halves to the closed position.

16. An apparatus for thermoforming a container from a heated foam sheet, the container comprising a base having a bottom wall and a peripheral wall upstanding from the bottom wall, and a cover hingedly mounted on the base and having a top wall and a peripheral wall depending from the top wall, one of the peripheral walls having a latch wipe opening, and the other of the peripheral walls having a locking tab sized to be received within the latch wipe opening to lock the cover in a closed position relative to the base, the apparatus comprising:
upper and lower mold halves, each of the mold halves having an inner surface in opposing relationship to the inner surface of the other of the mold halves, one of the inner surfaces having a container-forming portion for defining the interior of a container and the other of the inner surfaces having a container-forming portion for defining the exterior of a container, the mold halves being moveable between an open position thereof permitting the insertion of a heated foam sheet therebetween and a closed position thereof for positioning the foam sheet therebetween in conformity with the container-forming portions to form a container, and
a flange having a cooling surface and extending from one of the inner surfaces a sufficient distance for the cooling surface to contact a first portion of a heated foam sheet adjacent to the location where the latch wipe opening is to be formed before the first portion of the foam sheet is contacted by the container-forming portion of said one inner surface as the mold halves are moved to the closed position to thereby pre-cool a portion of a heated foam sheet.

17. An apparatus according to claim 16, further comprising an inner form provided on one of the mold halves and defining the container-forming portion of the inner surface thereof, and an outer form provided on the other of the mold halves and defining the container-forming portion of the inner surface thereof.

18. An apparatus according to claim 17, including a plurality of inner and outer forms provided on the mold halves in opposing pairs.

19. The apparatus according to claim 16, further comprising a textured surface provided on the container-forming portion of said one inner surface at a position to contact a second portion of a foam sheet adjacent to the location where a latch wipe opening is to be formed.

20. The apparatus according to claim 19, wherein said one inner surface is provided on the container-forming portion defining a container interior.

21. The apparatus according to claim 20, wherein the textured surface is a knurled portion on said one inner surface.

22. The apparatus according to claim 21, further comprising a shear key provided on said one inner surface and positioned below the knurled portion whereby, upon movement of the mold halves to the closed position thereof, the shear key forms a slit in a foam sheet to create the latch wipe opening and the knurled portion grips a portion of a foam sheet above the slit to control the shape of the latch wipe opening.

23. The apparatus according to claim 22, wherein the height and position of the flange are so selected that a portion of a foam sheet contacting the flange will lie below the shear key when the mold halves are in the closed position.

24. The apparatus according to claim 23, wherein the flange is moveably mounted on the mold half having said one inner surface and is moveable between an extended position thereof, wherein the cooling surface is positioned above said one inner surface when the mold halves are in the open position thereof, and a retracted position thereof, wherein the cooling surface is substantially co-planar with said one inner surface when the mold halves are in the closed position thereof.

25. The apparatus according to claim 24, wherein the mold half having said one inner surface is provided with an internal fluid conduit for circulating a coolant therethrough to maintain the flange cooling surface at a temperature lower than the temperature of a heated foam sheet.

26. A foam container comprising:
a base having a bottom wall and a peripheral wall extending from the bottom wall and having a latch wipe opening formed by the process of claim 1; and
a cover having a top wall and a peripheral wall extending from the top wall and having a locking tab extending therefrom, the peripheral walls being hingedly interconnected for movement between a closed position, wherein the cover overlies the base, and an open position, wherein the cover is retracted from the base, the locking tab being sized to be received within the latch wipe opening to lock the cover in the closed position.
